(19) United States
(12) Patent Application Publication
(10) Pub. No.: US 2007/0156929 A1
(43) Pub. Date: Jul. 5, 2007

(54) KEYBOARDLESS PORTABLE ELECTRONIC APPARATUS

(75) Inventors: Wen-Chuan Lian, Shenzhen (CN); Hua-Dong Cheng, Shenzhen (CN); Feng Zhou, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/616,028

(22) Filed: Dec. 26, 2006

(30) Foreign Application Priority Data
Dec. 30, 2005 (CN) 200510121407.0

(51) Int. Cl. G06F 3/00

(52) U.S. Cl. 710/8

(57) ABSTRACT

A keyboardless portable electronic apparatus is provided. Under a text input state, a display area of the apparatus includes a content display area, a function menu area, and a symbol selection area. The content display area is for displaying selection results of the navigational device. The function menu area is programmed with predetermined functions associating with text input. The symbol selection area is for displaying symbols thereon, the symbols are provided to be selected and generating a text to display on the content display area. The symbol selection area is further comprises a symbol selection menu and at least one symbol option lists. The symbol selection menu is visible all the time and the symbol option lists are visible only when a selection highlight of the apparatus is moved to the symbol selection menu.

### BACKGROUND OF THE INVENTION

1. Field of the Invention

The present invention relates generally to keyboardless portable electronic apparatus.

2. Description of Related Art

With the development of information industry, multifarious portable electronic apparatuses become commonly used tools in people's daily life and most of them, such as a cellphone, a PDA (Personal Data Assistant), and an electronic dictionary, are provided with a text input function. Commonly, for almost any one of the portable electronic apparatus, there exists a conflict between a display space and a weight, a volume of the portable electronic apparatus. If expanding the display space, it is inevitable to increase the volume as well as put on weight of the portable electronic apparatus. However, a portable electronic apparatus with a large volume and a heavy weight are usually unfavorable.

Taking the cellphone as an example, the cellphone includes a display part and an input part. If the display part and the input part are both located on a same plane as a bar phone does, increasing a display space of the display part will cause an increasing in the volume of the cellphone. If the display part is located on a plane different from that the input part situates on, as a folding mobile phone does, increasing a display space will cause an increasing in the thickness of the cellphone.

What is needed is a portable electronic apparatus, a method, and an interface for increasing a display space while not causing increasing the volume, weight and thickness thereof.

### SUMMARY OF THE INVENTION

A keyboardless portable electronic apparatus is provided. The apparatus comprises a display area and a navigational device. The display area displays contents thereon, and the navigational device controls a selection highlight moving in the display area to select highlight functions to be displayed on the display area. Under the text input state, the display area comprises a content display area and a function menu area. The content display area is for displaying the selection result of the navigational device and the function menu area is for displaying a function menu bar. The content display area comprises at least one menu options and a symbol selection area. The function menu area is programmed with predetermined functions associating with text input. The symbol selection area is for displaying symbols thereon, the symbols are provided to be selected and generating a text to display on the content display area. The symbol selection area is further comprises a symbol selection menu and at least one symbol option lists. The symbol selection menu is visible all the time and the one symbol option lists being visible only when a selection highlight of the apparatus is moved to the symbol selection menu.

Other advantages and novel features will be drawn from the following detailed description of the preferred embodiment with reference to the attached drawings, in which:

### BRIEF DESCRIPTION OF THE DRAWINGS

FIG. 1 is a schematic view of a keyboardless portable electronic apparatus of a preferred embodiment of the present invention, this view showing that the portable electronic apparatus is in a default state; and

FIG. 2 is a schematic view showing that the portable electronic apparatus of FIG. 1 is in a text input state.

### DETAILED DESCRIPTION OF THE INVENTION

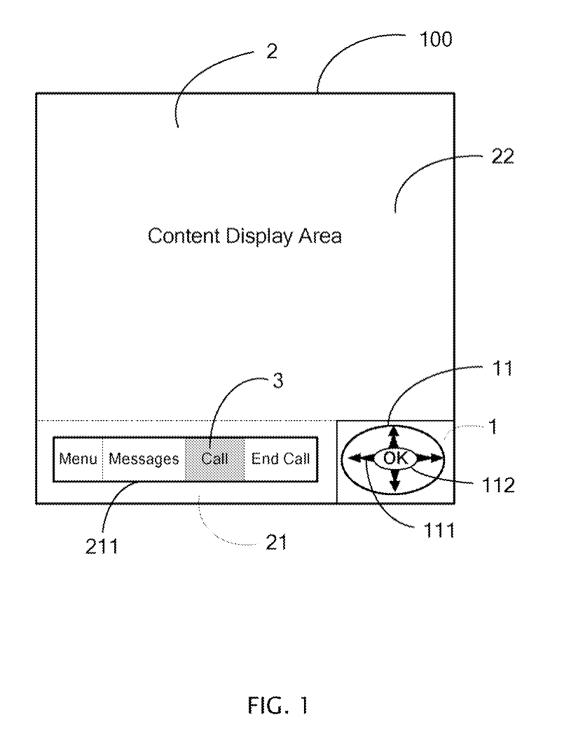

FIG. 1 is a schematic view of a keyboardless portable electronic apparatus in a default state in accordance with a preferred embodiment of the present invention. In the preferred embodiment, a cellphone 100 is taken as an example to describe the portable electronic apparatus. The cellphone 100 includes a navigational area 1 and a display area 2. The display area 2 occupies most section of the cellphone 100 while the navigational area 1 only occupies a bottom right corner section of the cellphone 100.

The display area 2 includes a function menu area 21 and a content display area 22. The function menu area 21 is located at a lower section of the display area 2 and is used to display a function menu bar 211. Generally, the function menu bar 211 includes one or more of menu options (not labeled). Each menu option is configured with a predetermined characters and/or icons. The characters and/or icons indicate the functionality of the menu option.

The navigational device 11 may be a navigational pad and is located in the navigational area 1 and used to control a selection highlight 3 moving in the display area 2. There are four directional pointers 111 labeled on the navigational pad, upward, downward, leftward and rightward. The navigational pad further includes a return button 112 on which an OK is labeled located in the centre of the navigational pad. The return button 112 is used for selecting a desired function that is highlighted by the selection highlight 3.

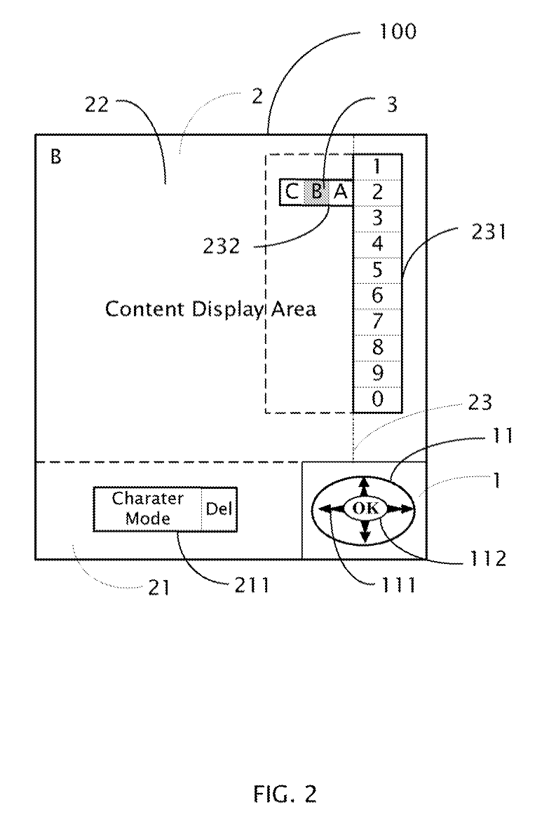

The cellphone 100 may be in a default state as depicted in FIG. 1 and a text input state as depicted in FIG. 2 and described later. When the cell phone is in the text input state, text can be inputted into the cellphone 100. Excepting the text input state, all other states of the cellphone 100 can be regarded as a default state such as a standby mode of the cellphone 100. FIG. 1 shows the cellphone 100 in a default state.

As depicted in FIG. 1, when the cellphone 100 in the default state, the function menu bar 21 includes a Menu option, a Message option, a call option, and an End Call option. When the Menu option is selected, a main menu is displayed on the content display area 22. The Message option is provided to enable the users to create, send, receive, view, edit, and organize text messages when selected. When a phone number is entered in the standby mode, or is selected from a phonebook stored in the cellphone 100, the call option can be selected to call the number. And the End Call option is provided to end a call or cancel a call attempt. While in the default state, the content display area 22 is used for displaying a result of implementing the predetermined function by the cellphone 100 in the default state. For example, when the cellphone 100 is in a standby mode, the content display area 22 displays information such as time, date, strength of a GSM network signal, and power status of the cellphone 100.

The selection highlight 3 can be moved through the function menu bar 211 back-and-forth by touching the directional pointers 111 of the navigational pad correspondingly, thus, highlighting a desired menu option. The return button 112 is used for selecting the highlighted menu option, thus commanding the cellphone 100 to invoke the desired function. The option results are then displayed in the content display area 22.

FIG. 2 is a schematic view of the foregoing cellphone 100 of FIG. 1 under a text input state. Under the text input state, the content display area 22 acts as a text display interface and the function menu bar 211 in the function menu area 21 displays menu options associated with text input. In FIG. 2, the menu options of the function menu bar 211 are given including a Character Mode menu option and a deletion (Del) menu option as examples. The Character mode option switches between different character modes such as a Chinese input mode or an English input mode when selected. The DEL menu option erases highlighted characters when selected. The navigational device 11 controls the selection highlight 3 to move through the menu options, thus highlighting a desired menu option. Under the text input state, the display area 2 further includes a symbol selection area 23 at the right section of the display area 2. The symbol selection area 23 is provided to select symbols and thus to generate a text in the content display area 22 under control of the navigational device 11. The symbol selection area 23 displays a symbol selection menu 231 and one or more symbol option lists 232.

The symbol selection menu 231 is always visible (permanently lays on top) when in the text input state and includes one or more pull-down symbol selection menus that marked with symbols such as characters and number. As FIG. 2 shows as an example, the symbol selection menu 231 includes ten pull-down symbol selection menus marked with number 0 to 9. According to the preferred embodiment, the selection highlight 3 can also be controlled to move between the pull-down symbol selection menus by the navigational device 11. The always-visible pull-down symbol selection menus are highlighted by the selection highlight 3 and the corresponding symbols (e.g., number 0 to 9) marked on the pull-down symbol selection menus are selected by the return button 112. Corresponding characters consequently generated and displayed on the content display area 22.

Each of the pull-down symbol selection menu corresponds to one symbol option list 232 that is only visible when the selection highlight 3 highlights the corresponding pull-down symbol selection menu. The symbol option list 132 is displayed in a direction vertical to the symbol selection menu 231 and includes one or more symbol options which are marked with symbols such as characters and numbers. The selection highlight 3 can further be controlled to move between the symbol options. The selection highlight 3 highlights the symbol options and selects the symbols marked on the symbol options to be displayed on the content display area 22. As FIG. 2 shows as an example, three symbol options respectively marked by characters A, B and C are visible when the selection highlight 3 reaches the pull-down symbol selection menu marked with the number 2. The selection highlight 3 is moved to and highlights symbol option marked by characters B. And then just to press the Return button 112 of the navigational pad, the character B is selected and displayed on the content display area 22.

Although the present invention has been specifically described on the basis of a preferred embodiment, the invention is not to be construed as being limited thereto. Various changes or modifications may be made to the embodiment without departing from the scope and spirit of the invention.

What is claimed is:

1. A keyboardless portable electronic apparatus operable in a text input state, the keyboardless portable electronic apparatus comprising a display area and a navigational device, the display area displaying contents thereon, and the navigational device controlling a selection highlight moving in the display area to select highlight functions to be displayed on the display area;
wherein, under the text input state, the display area comprises:
a content display area for displaying selection results of the navigational device;
a function menu area for displaying a function menu bar comprising at least one menu options programmed with predetermined functions associating with text input; and
a symbol selection area for displaying symbols thereon, the symbols being provided to be selected and generating a text to displayed on the content display area, comprising;
an symbol selection menu which is visible all the time; and
at least one symbol option lists being visible only when a selection highlight of the apparatus is moved to the symbol selection menu.

2. The apparatus as described in claim 1, wherein, the symbol selection menu is divided into at least one always-visible pull-down symbol selection menus marked with symbols.

3. The apparatus as described in claim 1, wherein each symbol option list is divided into at least one pull-down symbol selection menus marked with symbols.

4. The apparatus as described in claim 1, wherein, each pull-down symbol selection menus of the symbol selection menus corresponds to one symbol option list.

5. The text input interface as described in claim 4, wherein the symbol option list is vertical to the symbol selection menu.
